(19) United States
(12) Patent Application Publication
(10) Pub. No.: US 2025/0113209 A1
(43) Pub. Date: Apr. 3, 2025

(54) SYSTEMS AND METHODS FOR SIDELINK BEAM MANAGEMENT

(71) Applicant: QUALCOMM Incorporated, San Diego, CA (US)

(72) Inventors: Hua WANG, Basking Ridge, NJ (US); Sony AKKARAKARAN, Poway, CA (US); Kazuki TAKEDA, Tokyo (JP); Jelena DAMNJANOVIC, Del Mar, CA (US)

(21) Appl. No.: 18/477,905

(22) Filed: Sep. 29, 2023

(51) Int. Cl. H04W 16/28; H04W 72/0453; H04W 72/25; H04W 76/10

(52) U.S. Cl. CPC H04W 16/28; H04W 72/0453; H04W 72/25; H04W 76/10

(57) ABSTRACT

Wireless communications systems and methods related to sidelink communications between user equipments (UEs). A method of wireless communication performed by a first UE comprises establishing a connection with a second UE on a first frequency channel; transmitting, via the first frequency channel, an indication of resources on a second frequency channel; transmitting, via the second frequency channel using the indicated resources, one or more signals sweeping a plurality of beam directions; receiving, via the first frequency channel or the second frequency channel in response to transmitting the one or more signals, an index associated with a preferred beam direction; and communicating with the second UE in the second frequency channel using the preferred beam direction.

### TECHNICAL FIELD

This application relates to wireless communication systems, and more particularly to systems and methods for sidelink beam management.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects of the disclosure, a method of wireless communication performed by a first user equipment (UE) comprises establishing a connection with a second UE on a first frequency channel. The method further comprises transmitting, via the first frequency channel, an indication of resources on a second frequency channel. The method further comprises transmitting, via the second frequency channel using the indicated resources, one or more signals sweeping a plurality of beam directions. The method further comprises receiving, via the first frequency channel or the second frequency channel in response to transmitting the one or more signals, an index associated with a preferred beam direction. The method further comprises communicating with the second UE in the second frequency channel using the preferred beam direction.

In some aspects, a method of wireless communication performed by a first user equipment (UE) comprises establishing a connection with a second UE on a first frequency channel. The method further comprises receiving, via the first frequency channel, an indication of resources on a second frequency channel. The method further comprises receiving, via the second frequency channel over the indicated resources, one or more signals sweeping a plurality of beam directions. The method further comprises transmitting, via the first frequency channel or the second frequency channel in response to receiving the one or more signals, an index associated with a preferred beam direction. The method further comprises communicating with the second UE in the second frequency channel using the preferred beam direction.

In some aspects, a first user equipment (UE) comprises one or more memories and one or more processors coupled to the one or more memories storing instructions that are executable by the one or more processors, individually or in any combination, configured to cause the first UE to establish a connection with a second UE on a first frequency channel. The one or more processors are further configured to cause the first UE to transmit, via the first frequency channel, an indication of resources on a second frequency channel. The one or more processors are further configured to cause the first UE to transmit, via the second frequency channel using the indicated resources, one or more signals sweeping a plurality of beam directions. The one or more processors are further configured to cause the first UE to receive, via the first frequency channel or the second frequency channel in response to transmitting the one or more signals, an index associated with a preferred beam direction. The one or more processors are further configured to cause the first UE to communicate with the second UE in the second frequency channel using the preferred beam direction.

In some aspects, a first user equipment (UE) comprises one or more memories and one or more processors coupled to the one or more memories storing instructions that are executable by the one or more processors, individually or in any combination, configured to cause the first UE to establish a connection with a second UE on a first frequency channel. The one or more processors are further configured to cause the first UE to receive, via the first frequency channel, an indication of resources on a second frequency channel. The one or more processors are further configured to cause the first UE to receive, via the second frequency channel over the indicated resources, one or more signals sweeping a plurality of beam directions. The one or more processors are further configured to cause the first UE to transmit, via the first frequency channel or the second frequency channel in response to receiving the one or more signals, an index associated with a preferred beam direction. The one or more processors are further configured to cause the first UE to communicate with the second UE in the second frequency channel using the preferred beam direction.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 is a timing diagram illustrating a radio frame structure according to some aspects of the present disclosure.

FIG. 3 illustrates a wireless communication network that provisions for sidelink communications according to some aspects of the present disclosure.

FIG. 4 illustrates a beam management procedure according to some aspects of the present disclosure.

FIG. 5 is a sequence diagram illustrating a beam management scheme according to some aspects of the present disclosure.

FIGS. 6A-6B are timing diagrams of beam management schemes according to some aspects of the present disclosure.

FIG. 7 is a block diagram of an exemplary user equipment (UE) according to some aspects of the present disclosure.

FIG. 8 is a flow diagram of a wireless communication method according to some aspects of the present disclosure.

FIG. 9 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. In some implementations, the SCI in the PSCCH may referred to as SCI part 1 or SCI stage-1 (SCI-1), and additional SCI, which may be referred to as SCI part 2 or SCI stage-2 (SCI-2) may be carried in the PSSCH. The SCI-2 can include control information (e.g., transmission parameters, modulation coding scheme (MCS)) that are more specific to the data carrier in the PSSCH. Use cases for sidelink communication may include V2X, enhanced mobile broadband (eMBB), industrial IoT (IIOT), and/or NR-lite.

Wireless communications at high frequencies, such as mmWave frequency ranges, may experience a high path-loss compared to lower frequency bands that are commonly used in conventional communication systems. To overcome the high path-loss, BSs and UEs may use beamforming techniques to form directional beams for communications. For instance, a BS and/or a UE may be equipped with one or more antenna panels or antenna arrays with antenna elements that can be configured to focus transmit signal energy and/or receive signal energy in a certain spatial direction and/or within a certain spatial angular sector or width. A beam used for such wireless communications may be referred to as an active beam, a best beam, or a serving beam. The active beam may initially be selected from reference beams and then refined over time.

As used herein, the term “transmission beam” may refer to a transmitter transmitting a beamformed signal in a certain spatial direction or beam direction and/or with a certain beam width covering a certain spatial angular sector. The transmission beam may have characteristics such as the beam direction and the beam width. As used herein, the term “reception beam” may refer to a receiver using beamforming to receive a signal from a certain spatial direction or beam direction and/or within a certain beam width covering a certain spatial angular sector. The reception beam may have characteristics such as the beam direction and the beam width. As used herein, the term “beam sweep” or “beam sweeping” may refer to a wireless communication device using sequentially each beam of a set of predefined beams (directing to a set of predefined spatial directions) for transmissions or receptions over a time period to cover a certain angular sector spatially.

The present disclosure describes beam management techniques for sidelink communication between two UEs. Some UEs have the capability to transmit signals in a certain direction (e.g., via an array of antennas) known as a beam. To optimize communications, an ideal beam may be selected for communication between two devices. In some aspects, the transmitting UE uses a specific transmit beam, and the receiving UE uses a specific receive beam. In some aspects, a first frequency channel is utilized by the UEs in assisting beam management on another frequency channel. For example, in 5G communications, different frequency ranges may be designated. A first frequency range may be defined as 410-7,125 MHz (FR1), and a second frequency range may be defined as 24,250-52,600 MHz (FR2). Each of these frequency ranges may be used for different types of communications. For example, higher frequency bands such as those in FR2 may be better suited for short range high throughput communications. Sidelink communication between UEs may use frequency channels in both FR1 and FR2. In some aspects, one frequency channel (e.g., a frequency channel on FR1) may be used to support beam management on another channel (e.g., a frequency channel on FR2) including initial beam pairing, beam maintenance, beam failure recovery, etc.

In some aspects, first and second UEs may establish a connection (e.g., a unicast-link) using a first frequency channel (e.g., a component carrier on FR1). The first UE may send a message on the first frequency channel indicating resources on a second frequency channel (e.g., a component carrier on FR2) for a beam sweep. The first UE may use the indicated resources and transmit signals over a number of different beam directions on the second frequency channel. The second UE senses the beam sweep and determines the index of the preferred beam. The second UE may transmit an indication of the preferred beam to the first UE. Subsequent communications may then be performed between the first and second UEs using the preferred beam on the second frequency channel.

A number of benefits may be realized by a system implementing aspects described herein. For example, a connection may be maintained on one frequency channel (e.g., in FR1) while using the other frequency channel (e.g., in FR2) to improve throughput and/or reduce latency. In some aspects, the connection on a first frequency channel may be more robust, and therefore more reliable for maintaining connection and more likely to be able to help the connection on the other channel establish or recover after a beam failure. By reducing the communications on the second frequency channel, additional bandwidth may also be available for data throughput. This may result in more robust communications, with higher throughput, lower latency, and/or reduced power requirements.

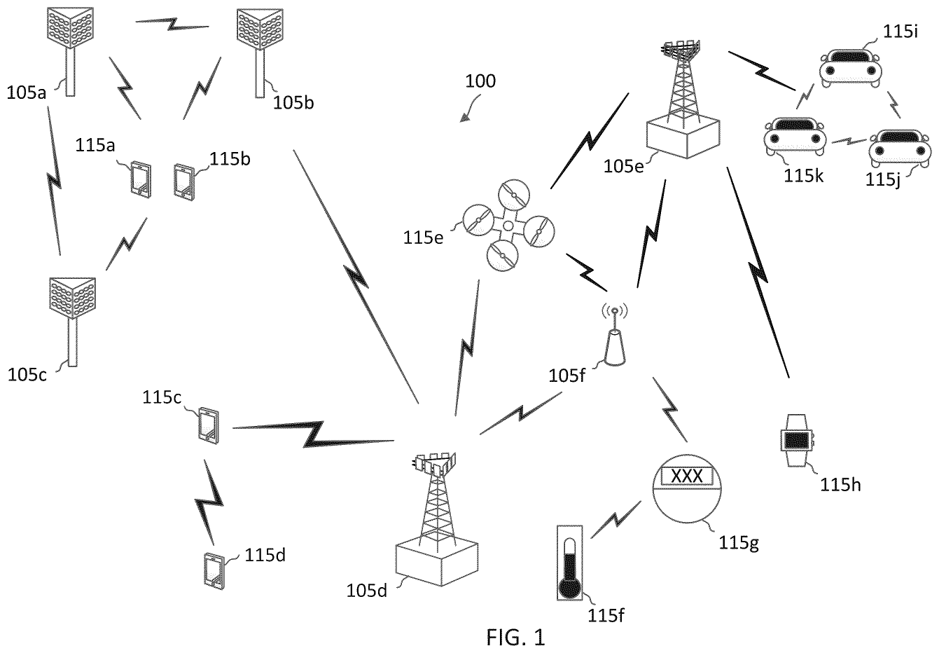

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission. The combined random access preamble and connection request in the two-step random access procedure may be referred to as a message A (MSG A). The combined random access response and connection response in the two-step random access procedure may be referred to as a message B (MSG B).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using hybrid automatic repeat request (HARQ) techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 decodes the DL data packet successfully, the UE 115 may transmit a HARQ acknowledgement (ACK) to the BS 105. Conversely, if the UE 115 fails to decode the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ an LBT procedure to monitor for transmission opportunities (TXOPs) in the shared channel. A wireless communication device may perform an LBT in the shared channel. LBT is a channel access scheme that may be used in the unlicensed spectrum. When the LBT results in an LBT pass (the wireless communication device wins contention for the wireless medium), the wireless communication device may access the shared medium to transmit and/or receive data. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. Conversely, the LBT results in a failure when a channel reservation signal is detected in the channel. A TXOP may also be referred to as channel occupancy time (COT).

In some aspects, the network 100 may provision for sidelink communications to allow a UE 115 to communicate with another UE 115 without tunneling through a BS 105 and/or the core network. As discussed above, sidelink communication can be communicated over a PSCCH and a PSSCH. For instance, the PSCCH may carry SCI and the PSSCH may carry SCI and/or sidelink data (e.g., user data). Each PSCCH is associated with a corresponding PSSCH, where SCI in a PSCCH may carry reservation and/or scheduling information for sidelink data transmission in the associated PSSCH. In some examples, a transmitting sidelink UE 115 may indicate SCI in two stages. In a first-stage SCI (which may be referred to as SCI-1), the UE 115 may transmit SCI in PSCCH carrying information for resource allocation and decoding a second-stage SCI. The first-stage SCI may include at least one of a priority, PSSCH resource assignment, resource reservation period (if enabled), PSSCH DMRS pattern (if more than one pattern is configured), a second-stage SCI format (e.g., size of second-stage SCI), an amount of resources for the second-stage SCI, a number of PSSCH demodulation reference signal (DMRS) port(s), a modulation and coding scheme (MCS), etc. In a second-stage SCI (which may be referred to as SCI-2), the UE 115 may transmit SCI in PSSCH carrying information for decoding the PSSCH. The second-stage SCI may include an 8-bit L1 destination identifier (ID), an 8-bit L1 source ID, a HARQ process ID, a new data indicator (NDI), a redundancy version (RV), etc. It should be understood that these are examples, and the first-stage SCI and/or the second-stage SCI may include or indicate additional or different information than those examples provided. Sidelink communication can also be communicated over a physical sidelink feedback control channel (PSFCH), which indicates an acknowledgement (ACK)-negative acknowledgement (NACK) for a previously transmitted PSSCH.

In some aspects, a sidelink communication can be in a unicast mode, a groupcast mode, or a broadcast mode, where HARQ may be applied to unicast and/or groupcast communications. For unicast communication, a sidelink transmitting UE 115 may transmit a sidelink transmission including data to a single sidelink receiving UE 115 and may request a HARQ acknowledgement/negative-acknowledgement (ACK/NACK) feedback from the sidelink receiving UE 115. If the sidelink receiving UE 115 successfully decoded data from the sidelink transmission, the sidelink receiving UE 115 transmits an ACK. Conversely, if the sidelink receiving UE 115 fails to decode data from the sidelink transmission, the sidelink receiving UE 115 transmits an NACK. Upon receiving a NACK, the sidelink transmitting UE 115 may retransmit the data. For broadcast communication, a sidelink transmitting UE 115 may transmit a sidelink transmission to a group of sidelink receiving UEs 115 (e.g., 2, 3, 4, 5, 6 or more) in a neighborhood of the sidelink transmitting UE 115 and may not request for an ACK/NACK feedback for the sidelink transmission.

For groupcast communication, a sidelink transmitting UE 115 may transmit a sidelink transmission to a group of sidelink receiving UEs 115 (e.g., 2, 3, 4, 5, 6 or more). Groupcast communication may have a wide variety of use cases in sidelink. As an example, groupcast communication can be used in a V2X use case (e.g., vehicle platooning) to instruct a group of vehicles nearby an intersection or traffic light to stop at the intersection. In some aspects, a groupcast communication can be connection-based, where the group of the sidelink receiving UEs 115 may be preconfigured as a group identified by a group identifier (ID). As such, the sidelink receiving UEs 115 in the group are known to the sidelink transmitting UE 115, and thus the sidelink transmitting UE 115 may request an ACK/NACK feedback from each sidelink receiving UE 115 in the group. In some instances, the sidelink transmitting UE 115 may provide each sidelink receiving UE with a different resource (e.g., an orthogonal resource) for transmitting an ACK/NACK feedback. In some other aspects, a groupcast communication can be connectionless, where the group of sidelink receiving UEs 115 that can receive the groupcast transmission may be unknown to the sidelink transmitting UE 115. In some instances, the group of sidelink receiving UEs 115 may receive the groupcast communication based on a zone or geographical location of the receiving UEs 115. Since the sidelink transmitting UE 115 may not have knowledge of the receiving sidelink UEs 115, the sidelink transmitting UE 115 may request an NACK-only feedback from the sidelink receiving UEs 115, referred to as a groupcast option-1 transmission. For instance, a sidelink receiving UE 115 may transmit an NACK if the sidelink receiving UE detected the presence of SCI, but fails to decode data (transport block) from the sidelink transmission. The sidelink receiving UE 115 may not transmit an ACK if the data decoding is successful. Groupcast option-2 transmission refers to the scenario where a sidelink receiving UE transmits an ACK if the data decoding is successful and transmits an NACK if the decoding fails. In some instances, the sidelink receiving UEs 115 may be assigned with the same resource for transmitting an NACK feedback. The simultaneous NACK transmission from multiple sidelink receiving UEs 115 in the same resource may form a single frequency network (SFN) transmission (where waveforms of the multiple NACK transmissions are combined) at the sidelink transmitting UE 115. Similar to the unicast communication, the sidelink transmitting UE 115 may retransmit sidelink data upon receiving an NACK for a connection-based or connectionless groupcast transmission.

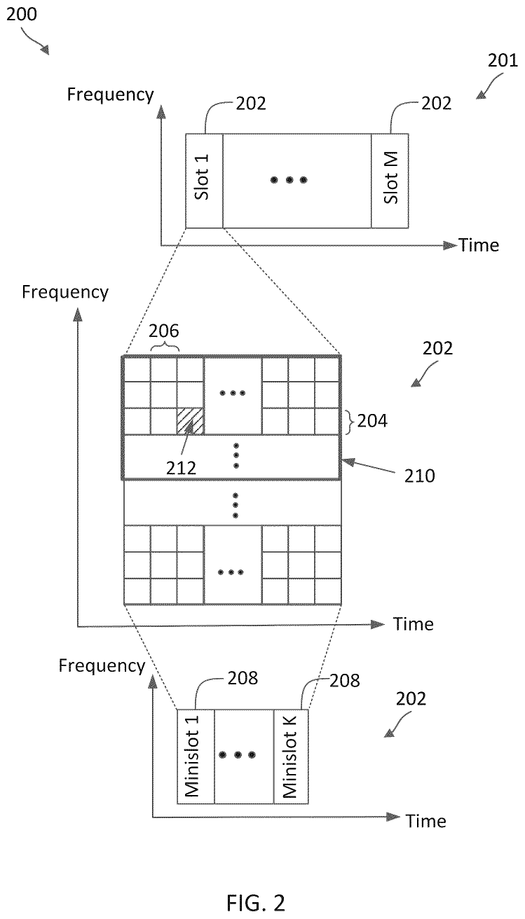

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The radio frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In some aspects, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204 in 1 symbol, 2 symbols, . . . , 14 symbols). In some aspects, a UE (e.g., UE 115i of FIG. 1) may communicate sidelink with another UE (e.g., UE 115j of FIG. 1) in units of time slots similar to the slot 202.

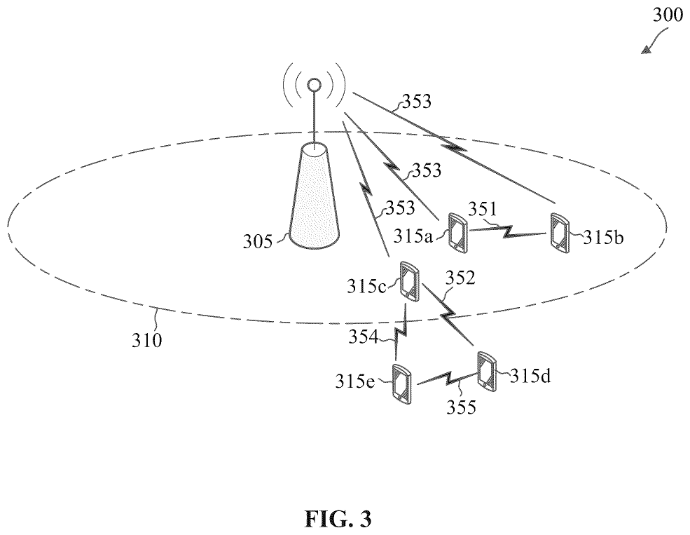

FIG. 3 illustrates an example of a wireless communication network 300 that provisions for sidelink communications according to aspects of the present disclosure. The network 300 may correspond to a portion of the network 100 may utilize the radio frame structure 200 for communications. FIG. 3 illustrates one BS 305 and five UEs 315 (shown as 315a, 315b, 315c, 315d, and 315e) for purposes of simplicity of discussion, though it will be recognized that aspects of the present disclosure may scale to any suitable number of UEs 315 (e.g., the about 2, 3, 4, 6, 7 or more) and/or BSs 305 (e.g., the about 2, 3 or more). The BS 305 and the UEs 315 may be similar to the BSs 105 and the UEs 115, respectively. The BS 305 and the UEs 315 may share the same radio frequency band for communications. In some instances, the radio frequency band may be a licensed band. In some instances, the radio frequency band may be an unlicensed band. In some instances, the radio frequency band may be a FR1 and/or FR2 band. In general, the radio frequency band may be at any suitable frequency.

In the network 300, some of the UEs 315 may communicate with each other in peer-to-peer communications. For example, the UE 315a may communicate with the UE 315b over a sidelink 351, the UE 315c may communicate with the UE 315d over a sidelink 352 and/or with the UE 315e over a sidelink 354, and the UE 315d may communicate with the UE 315e over a sidelink 355. The sidelinks 351, 352, 354, and 355 are unicast bidirectional links. In some aspects, the UE 315c may also communicate with the UE 315d and the UE 315e in a groupcast mode. Similarly, the UE 315d may also communicate with the UE 315c and the UE 315e in a groupcast mode. In general, the UEs 315c, 315d, an 315e may communicate with each other in a unicast mode or a groupcast mode. In some aspects, a COT-SI may be communicated via groupcast mode or unicast mode.

In the network 300, some of the UEs 315 may use beamforming for sidelink communication. Beam management may be performed by the UEs in order to establish and maintain optimal beam directions for sidelink communication. This may be performed at certain intervals or in response to an event such as a beam failure. Active beam management may allow sidelink communication between UEs 315 to be robust to movement of UEs and/or changes in the environment. In some aspects, UEs 315 may establish sidelink communications over multiple frequency channels. For example, UE 315a may communicate with UE 315b using a component carrier on FR1 and a component carrier on FR2. One or both of these communication links may utilize specific beams. The management of the beams on one frequency channel may be assisted by communications on the other frequency channel, as described herein.

Some of the UEs 315 may also communicate with the BS 305 in a UL direction and/or a DL direction via communication links 353. For instance, the UE 315a, 315b, and 315c are within a coverage area 310 of the BS 305, and thus may be in communication with the BS 305. The UE 315d and UE 315e are outside the coverage area 310, and thus may not be in direct communication with the BS 305. In some instances, the UE 315c may operate as a relay for the UE 315d to reach the BS 305. In some aspects, some of the UEs 315 are associated with vehicles (e.g., similar to the UEs 115i-k) and the communications over the sidelinks 351 and/or 352 may be C-V2X communications. C-V2X communications may refer to communications between vehicles and any other wireless communication devices in a cellular network.

The UEs 315 may wirelessly communicate with one another using resources associated with one or more carriers. The term “carrier” may refer to a set of RF spectrum resources having a defined physical layer structure for supporting the communication links. For example, a carrier used for a communication may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Network 300 may support communication between UEs 115 using carrier aggregation or multi-carrier operation. A UE 115 may be configured with multiple downlink component carriers and/or one or more uplink component carriers according to a carrier aggregation configuration. Carrier aggregation may be used with both frequency division duplexing (FDD) and/or time division duplexing (TDD) component carriers. In some instances, the radio frequency band may be a frequency range 1 (FR1) band. In some instances, one component carrier may be within the FR1 band, and another component carrier may be within the FR2 band.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

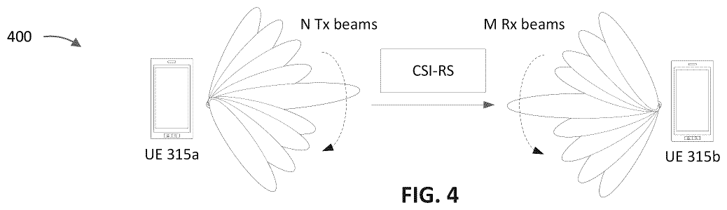

FIG. 4 illustrates a beam management procedure 400 according to some aspects of the present disclosure. As shown in FIG. 4, procedure 400 includes a UE 315a in communication with a UE 315b in a wireless network (e.g., wireless network 100 or 300).

In some aspects, UE 315a and UE 315b may establish a connection (e.g., a unicast-link) using a first frequency channel (e.g., a component carrier on FR1). UE 315a may send a message on the first frequency channel indicating resources on a second frequency channel (e.g., a component carrier on FR2) for a beam sweep. The first UE may use the indicated resources and transmit signals over a number of different beam directions (e.g., N Tx beams as illustrated) on the second frequency channel. UE 315b may sense the beam sweep and determine the index of the preferred beam. UE 315b may transmit an indication of the preferred beam to the first UE. Subsequent communications may then be performed between UE 315a and UE 315b using the preferred beam on the second frequency channel. In some aspects, UE 315b may also determine a preferred receive beam (e.g., of the M Rx receive beams illustrated).

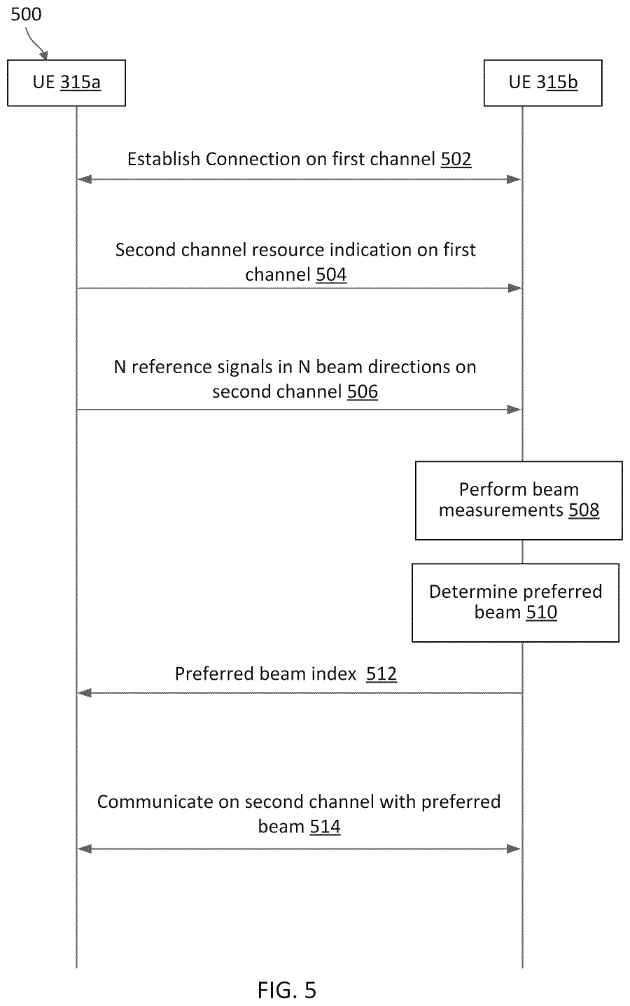

FIG. 5 is a sequence diagram illustrating a beam management method 500 according to some aspects of the present disclosure.

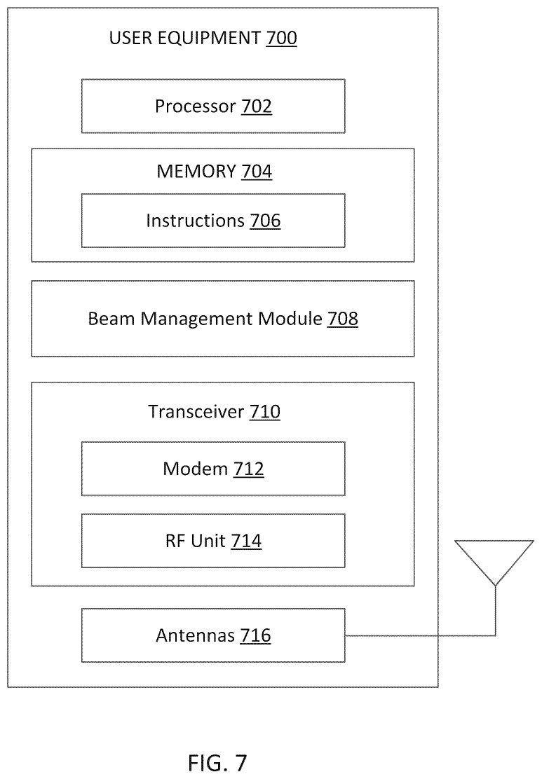

The method 500 may be performed by wireless networks, such as the networks 100 and/or 300 communicating over a high-frequency band, such as a mmWave band or a sub-THz band. In this regard, the method 500 is performed by a UEs 115, 315, or 700. The method 500 may employ similar mechanisms as discussed above with reference to FIG. 4. In some aspects, UE 315a and UE 315b may utilize one or more components, such as the processor 702, the memory 704, the beam management module 708, the transceiver 710, the modem 712, and the one or more antennas 716 shown in FIG. 7, to execute the actions of the method 500. As illustrated, the method 500 includes a number of enumerated action, but embodiments of the method 500 may include additional actions before, after, and in between the enumerated actions. In some aspects, one or more of the enumerated actions may be omitted or performed in a different order.

At action 502 UE 315a and UE 315b establish a connection on a first frequency channel. In some aspects, the first frequency channel is in 5G new radio (NR) frequency range 1 (FR1).

At action 504, UE 315a transmits, via the first frequency channel, an indication of resources on a second frequency channel to UE 315b. In some aspects, the second frequency channel is in 5G new radio (NR) frequency range 2 (FR2). In some aspects, the indication of resources is for an initial beam pairing. In some aspects, the indication of resources is part of a beam refinement process. In some aspects, the indication of resources is in response to a beam failure. In some aspects, the first UE further transmits a SCI using the second frequency channel indicating the indicated resources.

At action 506, the UE 315a transmits to UE 315b, via the second frequency channel using the indicated resources, a plurality of reference signals sweeping a plurality of beam directions. In some aspects, the reference signals may be one or more of a SL channel state information reference signa (CSI-RS), a SL synchronization signal block (SSB), or another SL reference signal. In some aspects, the plurality of beam directions are based on a first beam direction. For example, the UE 315a and UE 315b may already be in communication using a first beam direction, and the plurality of beam directions may be finer beams within the first beam direction in order to refine the beam being used for communication.

At action 508, UE 315b performs measurements on the received reference signals. For example, UE 315b may determine a reference signal received power (RSRP) for each beam. In some aspects, each beam is associated with an index. In some aspects, an index is indicated by the reference signal itself. In some aspects, the index is determined based on the resource used for the reference signal. For example, the beam transmitted using a first resource in time may be associated with an index 0, the next beam may be associated with an index 1 and so on.

At action 510, UE 315b determines a preferred beam direction. In some aspects, the preferred beam direction is based on the measurements performed at action 508. For example, the preferred beam direction may be the beam with the highest measured received power.

At action 512, UE 315b transmits to UE 315a, via the first frequency channel or the second frequency channel in response to receiving the one or more reference signals, an index associated with the preferred beam direction. In some aspects, UE 315a transmits an acknowledgment signal to UE 315b in response to receiving the index. In some aspects, the index is transmitted via a SCI or a sidelink medium access control-control element (SL MAC-CE) message.

At action 514, UE 315a and UE 315b communicate on the second frequency channel using the indicated preferred beam direction. In some aspects, the communication using the preferred beam direction is the first communication by UE 315b after a predefined delay after transmitting the index (e.g., 3 ms). In some aspects, the communicating using the preferred beam direction is performed by UE 315b after receiving the acknowledgment signal. In some aspects, the communication using the preferred beam direction is the first communication by UE 315a with UE 315b after receiving the index. In some aspects, the communicating using the preferred beam direction by UE 315a is performed after transmitting the acknowledgment signal.

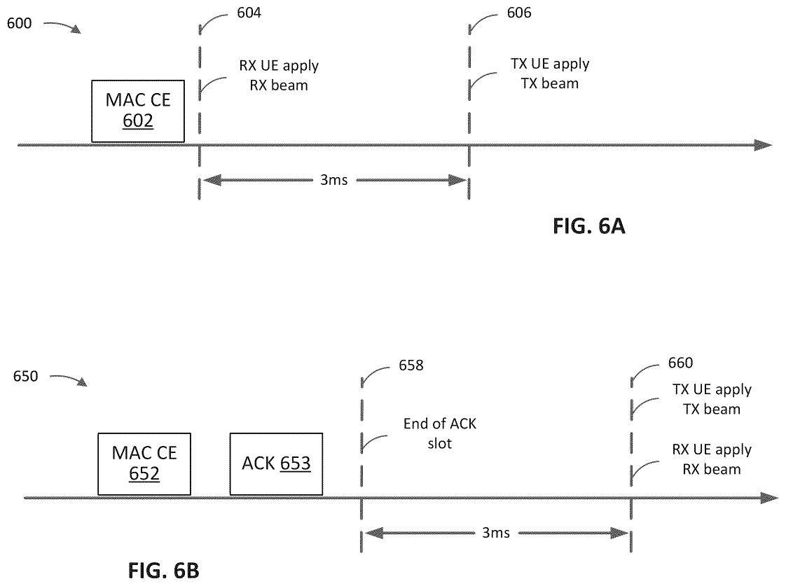

FIG. 6A is a timing diagram 600 of a beam management scheme according to some aspects of the present disclosure. The x-axis represents time in some units. Timing diagram 600 illustrates an exemplary timing for application of a preferred beam as described in FIG. 5 and other aspects described herein. MAC CE 602 is an exemplary message including an indication of a preferred beam index (e.g., as transmitted by UE 315b to UE 315a). In some aspects, at time 604, the receiving UE (e.g., UE 315b) applies the preferred receive beam immediately after transmitting the preferred beam direction. In some aspects, at time 606, the transmitting UE (e.g., UE 315a) applies the preferred transmit beam after a delay (e.g., 3 ms) after receiving the preferred beam index. In some aspects, the delay may be based on the length of a slot used in the second frequency channel.

FIG. 6B is a timing diagram 650 of a beam management scheme according to some aspects of the present disclosure. The x-axis represents time in some units. Timing diagram 600 illustrates an exemplary timing for application of a preferred beam as described in FIG. 5 and other aspects described herein. MAC CE 652 is an exemplary message including an indication of a preferred beam index (e.g., as transmitted by UE 315b to UE 315a). In some aspects, an acknowledgment signal 653 may be transmitted by the transmitting UE (e.g., UE 315a) to the receiving UE (e.g., UE 315b). For example, acknowledgment signal 653 may be transmitted when performing a beam refinement process, as the established beam may be a robust connection which may be used in transmitting an acknowledgment signal 653. Time 658 is the end of the slot in which acknowledgment signal 653 was transmitted/received. In some aspects, time 660 is delayed (e.g., 3 ms) after time 658. In some aspects, the delay is based on a slot length (e.g., one slot is 3 ms in length). In some aspects, the receiving UE (e.g., UE 315b) applies the preferred receive beam at time 660. In some aspects, the transmitting UE (e.g., UE 315a) applies the preferred transmit beam at time 660.

FIG. 7 is a block diagram of an exemplary UE 700 according to some aspects of the present disclosure. The UE 700 may be a UE 115 as discussed above with respect to FIG. 1. As shown, the UE 700 may include a processor 702, a memory 704, a beam management module 708, a transceiver 710 including a modem subsystem 712 and a radio frequency (RF) unit 714, and one or more antennas 716. These elements may be coupled with one another. The term “coupled” may refer to directly or indirectly coupled or connected to one or more intervening elements. For instance, these elements may be in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 1-6B, and 8-9. Instructions 706 may also be referred to as program code, which may be interpreted broadly to include any type of computer-readable statement(s). The program code may be for causing a wireless communication device to perform these operations, for example by causing one or more processors (such as processor 702) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The beam management module 708 may be implemented via hardware, software, or combinations thereof. For example, the beam management module 708 may be implemented as a processor, circuit, and/or instructions 706 stored in the memory 704 and executed by the processor 702. In some examples, the beam management module 708 can be integrated within the modem subsystem 712. For example, the beam management module 708 can be implemented by a combination of software components (e.g., executed by a DSP or a general processor) and hardware components (e.g., logic gates and circuitry) within the modem subsystem 712.

The beam management module 708 may communicate with various components of the UE 700 to perform aspects of the present disclosure, for example, aspects of FIGS. 1-6B, and 8-9. In some aspects, the beam management module 708 is configured to establish a connection with a second UE on a first frequency channel. Beam management module 708 may further be configured to communicate, via the first frequency channel, an indication of resources on a second frequency channel. Beam management module 708 may further be configured to communicate, via the second frequency channel using the indicated resources, a plurality of reference signals sweeping a plurality of beam directions. Beam management module 708 may further be configured to perform measurements of received reference signals and determine a preferred transmit and/or receive beam for communication based on the measurements. Beam management module 708 may further be configured to communicate, via the first frequency channel or the second frequency channel, an index associated with the preferred beam direction. Beam management module 708 may further be configured to communicate on the second frequency channel using the indicated preferred beam direction.

As shown, the transceiver 710 may include the modem subsystem 712 and the RF unit 714. The transceiver 710 can be configured to communicate bi-directionally with other devices, such as the BSs 105. The modem subsystem 712 may be configured to modulate and/or encode the data from the memory 704 and/or the beam management module 708 according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., PSCCH, PSSCH, SCI-1, SCI-2, sidelink data, COT-SI, COT sharing information such as but not limited to duration of the COT, time/frequency locations of the reserved COTs, offsets to COT reservations, starting subchannel of reserved COTs, resource widths of reserved COTs, etc.) from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together at the UE 115 to enable the UE 115 to communicate with other devices. In some aspects, the transceiver 710 may be configured to transmit a COT sharing information (COT-SI) configured to reserve one or more COTs in a sidelink channel over an unlicensed new radio (NR) band, the one or more COTs acquired via a channel access procedure by the beam management module 708, for instance, for a future transmission via the sidelink channel.

The RF unit 714 may provide the modulated and/or processed data, e.g. data packets (or, more generally, data messages that may include one or more data packets and other information), to the antennas 716 for transmission to one or more other devices. The antennas 716 may further receive data messages transmitted from other devices. The antennas 716 may provide the received data messages for processing and/or demodulation at the transceiver 710. The transceiver 710 may provide the demodulated and decoded data (e.g., PSCCH, PSSCH, SCI-1, SCI-2, sidelink data, COT-SI, COT sharing information) to the beam management module 708 for processing. The antennas 716 may include multiple antennas of similar or different designs in order to sustain multiple transmission links. The RF unit 714 may configure the antennas 716.

In an aspect, the UE 700 can include multiple transceivers 710 implementing different RATs (e.g., NR and LTE). In an aspect, the UE 700 can include a single transceiver 710 implementing multiple RATs (e.g., NR and LTE). In an aspect, the transceiver 710 can include various components, where different combinations of components can implement different RATs.

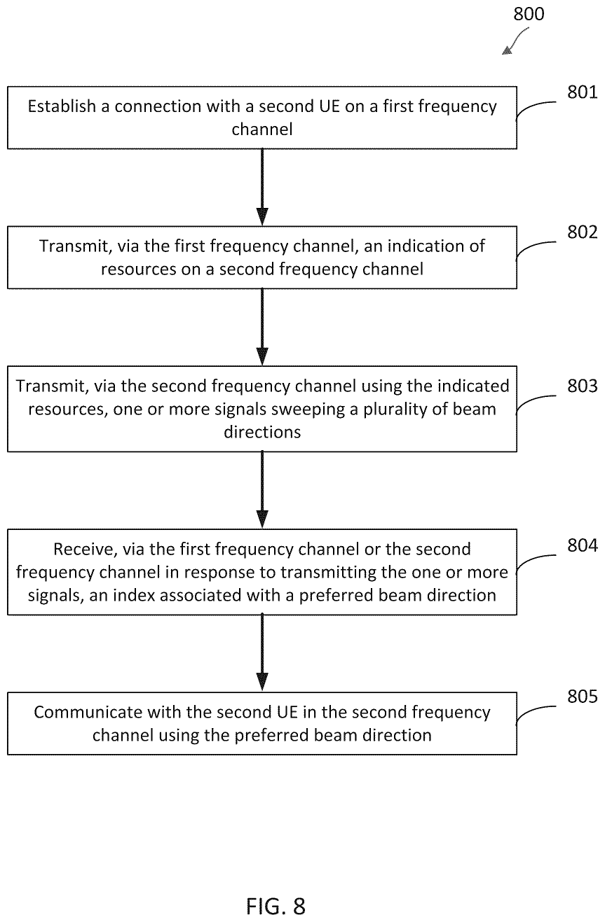

FIG. 8 is a flow diagram of a method 800 according to some aspects of the present disclosure. Aspects of the method 800 can be executed by a computing device (e.g., one or more memories and one or more processors coupled to the one or more memories storing instructions that are executable by the one or more processors, individually or in any combination, and/or other suitable components) of a wireless communication device or other suitable means for performing the steps. For example, a wireless communication device, such as the UEs 115, 315, or 700, may utilize one or more components, such as the processor 702, the memory 704, the beam management module 708, the transceiver 710, the modem 712, and the one or more antennas 716, to execute the steps of method 800. The method 800 may employ similar mechanisms as described above in FIGS. 1-7. As illustrated, the method 800 includes a number of enumerated steps, but aspects of the method 800 may include additional steps before, after, and in between the enumerated steps. In some aspects, one or more of the enumerated steps may be omitted or performed in a different order.

At block 801, in some aspects, a first UE (e.g., the UE 115, 315, or 700) establishes a connection with a second UE on a first frequency channel. In some aspects, the first frequency channel is in 5G new radio (NR) frequency range 1 (FR1).

At block 802, in some aspects, the first UE transmits, via the first frequency channel, an indication of resources on a second frequency channel. In some aspects, the second frequency channel is in 5G NR frequency range 2 (FR2). In some aspects, the indication of resources is for an initial beam pairing. In some aspects, the indication of resources is part of a beam refinement process. In some aspects, the indication of resources is in response to a beam failure. In some aspects, the first UE further transmits a SCI using the second frequency channel indicating the indicated resources based on a determination that another UE is not receiving signals on the first frequency channel. In some aspects, the transmitting a SCI indicating the indicated resources is based on the indicated resources being a periodic resource (e.g., a configured grant including resources repeating periodically for more than one instance). In some aspects, the first UE refrains from indicating the indicated resources in a SCI using the second frequency channel based on the indicated resources being an aperiodic resource (e.g., the resources do not repeat). In some aspects, the first UE refrains from indicating the indicated resources in a SCI using the second frequency channel based on a determination that another UE is communicating using both the first frequency channel and the second frequency channel.

At block 803, in some aspects, the first UE transmits, via the second frequency channel using the indicated resources, one or more signals sweeping a plurality of beam directions. In some aspects, the plurality of beam directions are based on a first beam direction. For example, the first UE and the second UE may already be in communication using a first beam direction, and the plurality of beam directions may be finer beams within the first beam direction in order to refine the beam being used for communication.

At block 804, in some aspects, the first UE receives, via the first frequency channel or the second frequency channel in response to transmitting the one or more signals, an index associated with a preferred beam direction. In some aspects, the first UE transmits an acknowledgment signal to the second UE in response to receiving the index.

At block 805, in some aspects, the first UE communicates with the second UE in the second frequency channel using the preferred beam direction. In some aspects, the communication using the preferred beam direction is the first communication by the first UE with the second UE after receiving the index. In some aspects, the communicating using the preferred beam direction is performed after transmitting the acknowledgment signal.

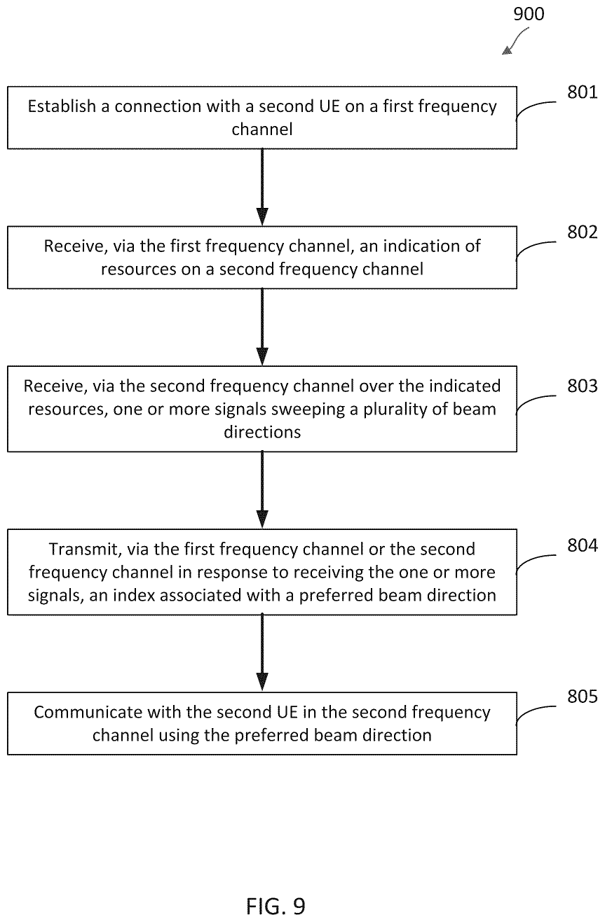

FIG. 9 is a flow diagram of a method 900 according to some aspects of the present disclosure. Aspects of the method 900 can be executed by a computing device (e.g., one or more memories and one or more processors coupled to the one or more memories storing instructions that are executable by the one or more processors, individually or in any combination, and/or other suitable components) of a wireless communication device or other suitable means for performing the steps. For example, a wireless communication device, such as the UEs 115, 315, or 700, may utilize one or more components, such as the processor 702, the memory 704, the beam management module 708, the transceiver 710, the modem 712, and the one or more antennas 716, to execute the steps of method 900. The method 900 may employ similar mechanisms as described above in FIGS. 1-7. As illustrated, the method 900 includes a number of enumerated steps, but aspects of the method 900 may include additional steps before, after, and in between the enumerated steps. In some aspects, one or more of the enumerated steps may be omitted or performed in a different order.

At block 901, in some aspects, a first UE (e.g., the UE 115, 315, or 700) establishes a connection with a second UE on a first frequency channel. In some aspects, the first frequency channel is in 5G new radio (NR) frequency range 1 (FR1) and the second frequency channel is in 5G NR frequency range 2 (FR2).

At block 902, in some aspects, the first UE receives, via the first frequency channel, an indication of resources on a second frequency channel. In some aspects, the indication of resources is for an initial beam pairing. In some aspects, the indication of resources is part of a beam refinement process. In some aspects, the indication of resources is in response to a beam failure. In some aspects, the first UE further transmits a SCI using the second frequency channel indicating the indicated resources.

At block 903, in some aspects, the first UE receives, via the second frequency channel using the indicated resources, one or more signals sweeping a plurality of beam directions. In some aspects, the plurality of beam directions are based on a first beam direction. For example, the first UE and the second UE may already be in communication using a first beam direction, and the plurality of beam directions may be finer beams within the first beam direction in order to refine the beam being used for communication.

At block 904, in some aspects, the first UE transmits, via the first frequency channel or the second frequency channel in response to receiving the one or more signals, an index associated with a preferred beam direction. In some aspects, the first UE receives an acknowledgment signal to the second UE in response to receiving the index. In some aspects, the index is transmitted via a SCI or a sidelink medium access control-control element (SL MAC-CE) message.

At block 905, in some aspects, the first UE communicates with the second UE in the second frequency channel using the preferred beam direction. In some aspects, the communication using the preferred beam direction is the first communication by the first UE after a predefined delay after transmitting the index (e.g., 3 ms). In some aspects, the communicating using the preferred beam direction is performed after receiving the acknowledgment signal.

### RECITATIONS OF SOME ASPECTS OF THE PRESENT DISCLOSURE

Aspect 1. A method of wireless communication performed by a first user equipment (UE), the method comprising:
establishing a connection with a second UE on a first frequency channel;
transmitting, via the first frequency channel, an indication of resources on a second frequency channel;
transmitting, via the second frequency channel using the indicated resources, one or more signals sweeping a plurality of beam directions;
receiving, via the first frequency channel or the second frequency channel in response to transmitting the one or more signals, an index associated with a preferred beam direction; and
communicating with the second UE in the second frequency channel using the preferred beam direction.

Aspect 2. The method of aspect 1, wherein the communicating using the preferred beam direction is the first communication by the first UE with the second UE after receiving the index.

Aspect 3. The method of any of aspects 1-2, further comprising:
transmitting an acknowledgement signal to the second UE in response to receiving the index,
wherein the communicating using the preferred beam direction is performed after transmitting the acknowledgement signal.

Aspect 4. The method of any of aspects 1-3, wherein the first frequency channel is in 5G new radio (NR) frequency range 1 (FR1) and the second frequency channel is in 5G NR frequency range 2 (FR2).

Aspect 5. The method of any of aspects 1-4, further comprising transmitting a sidelink control information (SCI) using the second frequency channel indicating the indicated resources based on a determination that a third UE is not receiving signals on the first frequency channel and further based on the indicated resources being a periodic resource.

Aspect 6. The method of any of aspects 1-4, further comprising refraining from indicating the indicated resources in a sidelink control information (SCI) using the second frequency channel based on the indicated resources being an aperiodic resource.

Aspect 7. The method of any of aspects 1-4, further comprising refraining from indicating the indicated resources in a sidelink control information (SCI) using the second frequency channel based on a determination that a third UE is communicating using both the first frequency channel and the second frequency channel.

Aspect 8. The method of any of aspects 1-7, wherein the transmitting the indication of resources on the second frequency channel is in response to a beam failure on the second frequency channel.

Aspect 9. The method of any of aspects 1-8, further comprising:
communicating with the second UE in the second frequency channel using a first beam direction, wherein the plurality of beam directions are based on the first beam direction.

Aspect 10. A method of wireless communication performed by a first user equipment (UE), the method comprising:
establishing a connection with a second UE on a first frequency channel;
receiving, via the first frequency channel, an indication of resources on a second frequency channel;
receiving, via the second frequency channel over the indicated resources, one or more signals sweeping a plurality of beam directions;
transmitting, via the first frequency channel or the second frequency channel in response to receiving the one or more signals, an index associated with a preferred beam direction; and
communicating with the second UE in the second frequency channel using the preferred beam direction.

Aspect 11. The method of aspect 10, wherein the communicating using the preferred beam direction is the first communication by the first UE after a predefined delay after transmitting the index.

Aspect 12. The method of any of aspects 10-11, further comprising:
receiving an acknowledgement signal associated with the index from the second UE,
wherein the communicating using the preferred beam direction is performed after receiving the acknowledgement signal.

Aspect 13. The method of any of aspects 10-12, wherein the first frequency channel is in 5G new radio (NR) frequency range 1 (FR1) and the second frequency channel is in 5G NR frequency range 2 (FR2).

Aspect 14. The method of any of aspects 10-13, further comprising receiving a sidelink control information (SCI) via the second frequency channel indicating the indicated resources.

Aspect 15. The method of any of aspects 10-14, wherein the transmitting the index comprises transmitting the index via a sidelink control information (SCI) or a sidelink medium access control-control element (SL MAC-CE) message.

Aspect 16. A first UE, comprising one or more memories and one or more processors coupled to the one or more memories storing instructions that are executable by the one or more processors, individually or in any combination, configured to cause the first UE to perform the methods of any of aspects 1-15.

Aspect 17. A non-transitory computer-readable medium (CRM) having program code recorded thereon, the program code comprises code for causing a first UE to perform the methods of any of aspects 1-15.

Aspect 18. A first UE comprising means for performing the methods of any of aspects 1-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication performed by a first user equipment (UE), the method comprising:
establishing a connection with a second UE on a first frequency channel;
transmitting, via the first frequency channel, an indication of resources on a second frequency channel;
transmitting, via the second frequency channel using the indicated resources, one or more signals sweeping a plurality of beam directions;
receiving, via the first frequency channel or the second frequency channel in response to transmitting the one or more signals, an index associated with a preferred beam direction; and
communicating with the second UE in the second frequency channel using the preferred beam direction.

2. The method of claim 1, wherein the communicating using the preferred beam direction is the first communication by the first UE with the second UE after receiving the index.

3. The method of claim 1, further comprising:
transmitting an acknowledgement signal to the second UE in response to receiving the index,
wherein the communicating using the preferred beam direction is performed after transmitting the acknowledgement signal.

4. The method of claim 1, wherein the first frequency channel is in 5G new radio (NR) frequency range 1 (FR1) and the second frequency channel is in 5G NR frequency range 2 (FR2).

5. The method of claim 1, further comprising
transmitting a sidelink control information (SCI) using the second frequency channel indicating the indicated resources based on a determination that a third UE is not receiving signals on the first frequency channel and further based on the indicated resources being a periodic resource.

6. The method of claim 1, further comprising
refraining from indicating the indicated resources in a sidelink control information (SCI) using the second frequency channel based on the indicated resources being an aperiodic resource.

7. The method of claim 1, further comprising
refraining from indicating the indicated resources in a sidelink control information (SCI) using the second frequency channel based on a determination that a third UE is communicating using both the first frequency channel and the second frequency channel.

8. The method of claim 1, wherein the transmitting the indication of resources on the second frequency channel is in response to a beam failure on the second frequency channel.

9. The method of claim 1, further comprising:
communicating with the second UE in the second frequency channel using a first beam direction,
wherein the plurality of beam directions are based on the first beam direction.

10. A method of wireless communication performed by a first user equipment (UE), the method comprising:
establishing a connection with a second UE on a first frequency channel;
receiving, via the first frequency channel, an indication of resources on a second frequency channel;
receiving, via the second frequency channel over the indicated resources, one or more signals sweeping a plurality of beam directions;
transmitting, via the first frequency channel or the second frequency channel in response to receiving the one or more signals, an index associated with a preferred beam direction; and
communicating with the second UE in the second frequency channel using the preferred beam direction.

11. The method of claim 10, wherein the communicating using the preferred beam direction is the first communication by the first UE after a predefined delay after transmitting the index.

12. The method of claim 10, further comprising:
receiving an acknowledgement signal associated with the index from the second UE,
wherein the communicating using the preferred beam direction is performed after receiving the acknowledgement signal.

13. The method of claim 10, wherein the first frequency channel is in 5G new radio (NR) frequency range 1 (FR1) and the second frequency channel is in 5G NR frequency range 2 (FR2).

14. The method of claim 10, further comprising
receiving a sidelink control information (SCI) via the second frequency channel indicating the indicated resources.

15. The method of claim 10, wherein the transmitting the index comprises transmitting the index via a sidelink control information (SCI) or a sidelink medium access control-control element (SL MAC-CE) message.

16. A first user equipment (UE), comprising:
one or more memories; and
one or more processors coupled to the one or more memories storing instructions that are executable by the one or more processors, individually or in any combination, configured to cause the first UE to:
establish a connection with a second UE on a first frequency channel;
transmit, via the first frequency channel, an indication of resources on a second frequency channel;
transmit, via the second frequency channel using the indicated resources, one or more signals sweeping a plurality of beam directions;
receive, via the first frequency channel or the second frequency channel in response to transmitting the one or more signals, an index associated with a preferred beam direction; and
communicate with the second UE in the second frequency channel using the preferred beam direction.

17. The first UE of claim 16, wherein the one or more processors are further configured to communicate using the preferred beam direction as the first communication by the first UE with the second UE after receiving the index.

18. The first UE of claim 16, the one or more processors further configured to cause the first UE to:
transmit an acknowledgement signal to the second UE in response to receiving the index; and
communicate using the preferred beam direction is performed after transmitting the acknowledgement signal.

19. The first UE of claim 16, wherein the first frequency channel is in 5G new radio (NR) frequency range 1 (FR1) and the second frequency channel is in 5G NR frequency range 2 (FR2).

20. The first UE of claim 16, the one or more processors further configured to cause the first UE to:
transmit a sidelink control information (SCI) using the second frequency channel indicating the indicated resources based on a determination that a third UE is not receiving signals on the first frequency channel and further based on the indicated resources being a periodic resource.

21. The first UE of claim 16, the one or more processors further configured to cause the first UE to:
refrain from indicating the indicated resources in a sidelink control information (SCI) using the second frequency channel based on the indicated resources being an aperiodic resource.

22. The first UE of claim 16, the one or more processors further configured to cause the first UE to:
refrain from indicating the indicated resources in a sidelink control information (SCI) using the second frequency channel based on a determination that a third UE is communicating using both the first frequency channel and the second frequency channel.

23. The first UE of claim 16, the one or more processors further configured to cause the first UE to:
transmit the indication of resources on the second frequency channel in response to a beam failure on the second frequency channel.

24. The first UE of claim 16, the one or more processors further configured to cause the first UE to:
communicate with the second UE in the second frequency channel using a first beam direction,
wherein the plurality of beam directions are based on the first beam direction.

25. A first user equipment (UE), comprising:
one or more memories; and
one or more processors coupled to the one or more memories storing instructions that are executable by the one or more processors, individually or in any combination, configured to cause the first UE to:
establish a connection with a second UE on a first frequency channel;
receive, via the first frequency channel, an indication of resources on a second frequency channel;
receive, via the second frequency channel over the indicated resources, one or more signals sweeping a plurality of beam directions;
transmit, via the first frequency channel or the second frequency channel in response to receiving the one or more signals, an index associated with a preferred beam direction; and
communicate with the second UE in the second frequency channel using the preferred beam direction.

26. The first UE of claim 25, the one or more processors further configured to cause the first UE to:
communicate using the preferred beam direction as the first communication by the first UE after a predefined delay after transmitting the index.

27. The first UE of claim 25, the one or more processors further configured to cause the first UE to:
receive an acknowledgement signal associated with the index from the second UE; and
communicate using the preferred beam direction is performed after receiving the acknowledgement signal.

28. The first UE of claim 25, wherein the first frequency channel is in 5G new radio (NR) frequency range 1 (FR1) and the second frequency channel is in 5G NR frequency range 2 (FR2).

29. The first UE of claim 25, the one or more processors further configured to cause the first UE to:
receive a sidelink control information (SCI) via the second frequency channel indicating the indicated resources.

30. The first UE of claim 25, the one or more processors further configured to cause the first UE to:
transmit the index comprises transmitting the index via a sidelink control information (SCI) or a sidelink medium access control-control element (SL MAC-CE) message.
